(19) United States
(12) Patent Application Publication
(10) Pub. No.: US 2008/0228994 A1
(43) Pub. Date: Sep. 18, 2008

(54) Solid memory module structure with extensible capacity

(76) Inventors: Li Hui Lu, Chupei (TW); Kun Lin Liu, Chupei (TW)

Correspondence Address: PRO-TECHTOR INTERNATIONAL SERVICES, 20775 NORADA CT., SARATOGA, CA, 95070, US

(21) Appl. No.: 11/800,140

(22) Filed: May 4, 2007

(30) Foreign Application Priority Data
Mar. 14, 2007 (TW) 96108703

(51) Int. Cl. G06F 13/28

(52) U.S. Cl. 711/102

(57) ABSTRACT

A solid memory module structure with extensible capacity includes at least a non-volatile memory module, each of which has at least a memory chip, a first connector, and a control unit. And A Solid memory module includes at least a second connector, which electrically connects the first connector of the volatile memory module, and a system interfac3. The control unit of the non-volatile memory module obtains external signals by this system interface and then transmits to this non-volatile memory module by the control unit to store or use the memory content.

### BACKGROUND OF THE INVENTION

1. Field of the Invention

The present invention relates to a solid memory module structure with extensible capacity, especially a memory capacity one which can plant more than one non-volatile memory module into the presetting connector of solid memory module in order to achieve the purpose of expanding or replacing the non-volatile memory as well as improving the solid memory

2. Description of the Related Art

Since the June, 2006, flash solid state disk (SSD) embedded 32 G NAND has be launched, and it was declared that it was the first NAND flash solid state disk deployed for commercial behavior computer application and lifted the curtain on the non-volatile memory replacing the disk. It is described that the slid state disk can bear the twice collision and damage than that of common disk, in addition, when PC is suffered falling and touching or water dipping, it will be easier to bring the storage from the flash memory than the disk. Moreover, the data respeed of solid state disk is 53 Mpbs, which is the 3 times than that of common disk; and the write speed is 28 Mbps, which increases 150% than that of the disk. The advantage equipped with this flash solid state disk is that weight of SSD is only half of the common rotating disk. Therefore, this laptop computer with data storage medium will pick up the speed of uploading or downloading data, and the course of processing data is relatively quiet on the ground that SSD uses static NAND quick memory chip which can be able to grasp, and non Winchester disk drive uses the dial, moreover, SSD can save 95% electricity by the Winchester disk drive.

This invention relates to a solid memory module with extensible capacity in order to solve some disadvantages about the study and technology.

### SUMMARY OF THE INVENTION

The objective of this invention is to provide a solid memory module structure with extensible capacity which can contain more than one non-volatile memory module by passing through the presetting slot of solid memory module or replace non-volatile memory module so as to effectively expand the solid memory module capacity and make consumers select the memory modules freely as well as enlarge the capacity of solid state disk.

Another objective of this invention is to provide a solid memory module structure with extensible capacity which assembles non-volatile memory module into the solid memory module in an embedded way easily.

Another objective of this invention is to provide a solid memory module structure with extensible capacity which makes computer facilities select the memory module with specific capacity according to requirements of consumers. Computer manufacturer need not install the non-volatile memory module with large memory capacity beforehand, thus being able to reduce the risks of loss form falling price caused by the memory price fluctuations.

In order to achieve the above objectives, features of this invention, the present invention includes at least a non-volatile memory module, each of which has at least a non-volatile memory chip, a first connector, and a control unit, as well as a solid memory module includes at least a second connector, which electrically connects the first connector of the volatile memory module, and a system interface. The control unit obtains external signals by this system interface and then transmits to this non-volatile memory module by the control unit to store or use the memory content.

Therefore, the purpose of expanding the memory capacity of this invention is to increase the capacity of solid memory module by means of replacing this non-volatile memory module or increase the number of non-volatile memory module.

### BRIEF DESCRIPTION OF THE DRAWINGS

FIG. 1 is a first schematic illustration showing a solid memory module with extensible capacity of the present invention.

FIG. 2 is the second schematic illustration showing a solid memory module structure with extensible capacity of the present invention.

FIG. 3 is the third schematic illustration showing a solid memory module structure with extensible capacity of the present invention.

FIG. 4 is the fourth illustration showing a solid memory module structure with extensible capacity of the present invention.

FIG. 5 is a schematic illustration showing a solid memory module structure with extensible capacity of the present invention.

### DETAILED DESCRIPTION OF THE INVENTION

In order to explain other features and advantages of this invention and reach more obvious functions, hereby this invention and attached drawings are specified in the following:

Please refer to FIG. 1. It is the schematic drawing of solid memory module structure with extensible capacity, which includes two non-volatile memory modules 10 and a solid memory module 12. Wherein

In the preferred embodiment, every non-volatile memory module 10 has four non-volatile memory chips 14, which is a kind of flash chip and packaged on a printing circular board 15, as well as a first connector 16 connected on every non-volatile memory chip 14 and used as transmission of the high frequency signals, and a control unit 18, which a control chip 20 and a frequency generator 22.

And in this execution, solid memory module 12 has two second connectors 24 and a system interface 26, which are all installed on a printing circular board 28. The system interface 26 includes a IDE RAID controller 30 and a IDE to SATA conversion chip 32. The control unit 18 of the non-volatile memory module 10 may obtains external signals by the system interface 26, and then transmitted to this non-volatile memory module 20 by the control unit 18 to store or use the memory content.

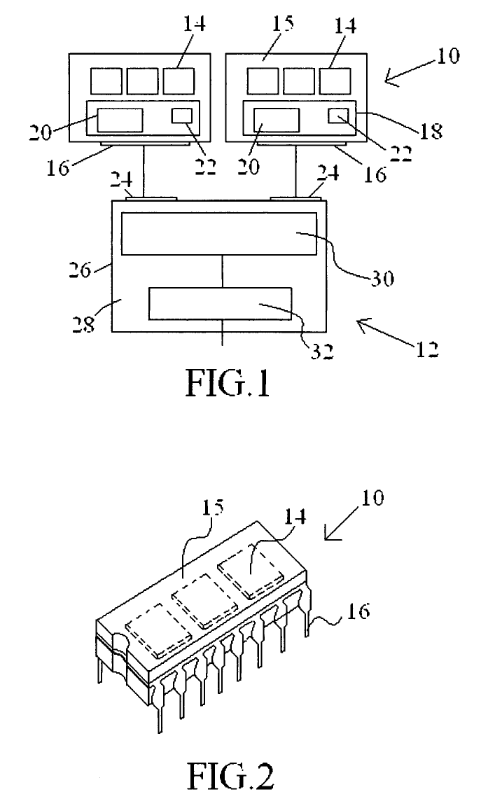

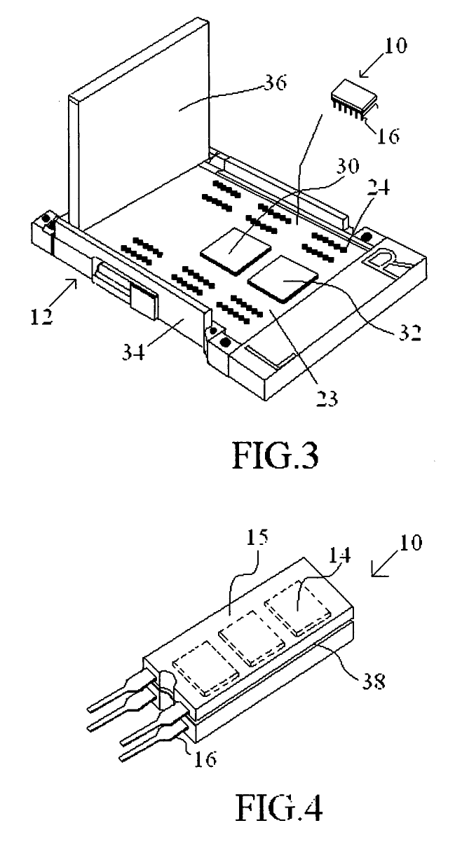

Please refer to FIG. 2. It is a schematic illustration of non-volatile memory module structure of this invention. The first connector 16 of non-volatile memory module 10 is an electrical pin. Please refer to FIG. 3, which is a schematic illustration of solid memory module with extensible capacity. The solid memory module 12 is installed within the shell 34 which has an upper cover 36 for opening. The second connector 24 is a slot in the printing circular board 28 used as inserting of the electrical pin of non-volatile memory module 10 for expanding or replacing its memory capacity.

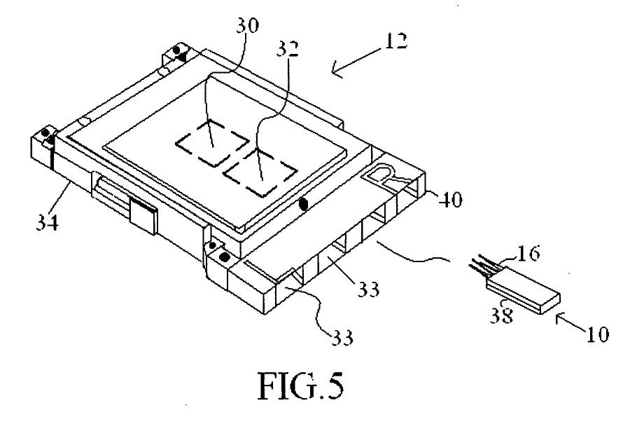

Please refer to FIG. 4. It is another schematic illustration of non-volatile memory module of this invention. The first connector 16 of non-volatile memory module 10 is an electrical pin and both sides of this module have the sliding chute 38. Please refer to FIG. 5, which is another execution drawing of solid memory module with extensible capacity. The solid memory module 12 is installed within the shell 32 which is equipped with several sockets 33 used as inserting of the electrical pin of non-volatile memory module 10 and connected electrically the first connector 16 with the second connector 24 of the solid memory module 12 for expanding or replacing its memory capacity. Both sides of the socket 33 have the first slider 40 so as to work in with sliding and seizing the second slider 38 in the both sides of non-volatile memory module 10.

From the above discussed, this invention has achieved improvement functions by means of breaking through the prior technology structures and cannot be devised easily by persons who are not familiar with this skill. Moreover, this invention has not been public before application, whose evolutionarity, practicality and novelty have obviously in accordance with the patent application conditions. Therefore, I, with great appreciation, present the invention application in conformity with a law and earnestly request you to examine and approve my application for patent so as to encourage the creation.

The above execution methods are only the technology thoughts and features of this invention in order that persons familiar with this skill can understand the content of this invention and then implement based on it. The patent scope of this invention cannot be limited and still covers the same change or modification revealed according to this invention.

What is claimed is:

1. A solid memory module structure with extensible capacity, comprising:
At least a non-volatile memory module, each of which has at least a non-volatile memory chip, a first connector, and a control unit; and
A solid memory module including at least a second connector, which electrically connects the first connector of the volatile memory module, and a system interface, the control unit may obtains external signals by the system interface, and then transmitted to this non-volatile memory module by the control unit to store or use the memory content.

2. A solid memory module structure with extensible capacity according to claim 1, wherein this non-volatile memory chip is the Flash.

3. A solid memory module structure with extensible capacity according to claim 1, wherein the control unit of the non-volatile memory module includes a control chip and a frequency generator.

4. A solid memory module structure with extensible capacity according to claim 1, wherein the non-volatile memory chip, a first connector, and a control unit of non-volatile memory module are installed at a printing circuit board.

5. A solid memory module structure with extensible capacity according to claim 1, wherein the system interface and second connector of the solid are installed at a printing circuit board.

6. A solid memory module structure with extensible capacity according to claim 1, wherein the system interface includes a IDE RAID controller and the IDE to SATA conversion chip.

7. A solid memory module with extensible capacity according to claim 1, wherein the module includes a shell within which this solid memory module is installed.

8. A solid memory module with extensible capacity according to claim 7, wherein the shell is equipped with at least one slots, which can make the first connector of this non-volatile memory module inset into this slot, and is electrically connected with the second connector of this solid memory module.

9. A solid memory module with extensible structure capacity according to claim 8, wherein the slot has the first slider and this non-volatile memory is equipped with the second slider for sliding into this slot.

10. A solid memory module structure with extensible capacity, it is used for assembling more than one non-volatile memory module, which includes at least a memory chip, a first connector, and a control unit, the structure comprising:
At least one second connector used for connecting electrically with the first connector of the non-volatile memory module; and
A system interface; and
The control unit of the non-volatile may obtained external signals and then transmits to the non-volatile memory module by control unit to store or use the memory content by this system interface.

11. A solid memory module structure with extensible capacity according to claim 10, wherein the control unit includes a control chip and a frequency generator.

12. A solid memory module structure with extensible capacity according to claim 10, wherein the system interface and the second connector of the solid memory module are formed at a printing circuit board.

13. A solid memory module structure with extensible capacity according to claim 10, wherein the system interface at least includes the IDE RAID controller and the IDE to SATA conversion chip.

14. A solid memory module structure with extensible capacity according to claim 10, wherein the module includes a shell within which this solid memory module is installed.

15. A solid memory module structure with extensible capacity according to claim 14, wherein the shell is equipped with more than one slots, which can make the first connector of this non-volatile memory module inset into this slot, and is electrically connected with the second connector of this solid memory module.

16. A solid memory module structure with extensible capacity according to claim 15, wherein the slot has the first slider and this non-volatile memory is equipped with the second slider for sliding into this slot.
